(19) United States
(12) Patent Application Publication
(10) Pub. No.: US 2020/0242565 A1
(43) Pub. Date: Jul. 30, 2020

(54) COMPUTING SYSTEMS FOR MANAGING ELECTRONIC CALENDAR ITEMS

(71) Applicant: Microsoft Technology Licensing, LLC, Redmond, WA (US)

(72) Inventors: Niranjan Vasu, Sammamish, WA (US); Jason Lacombe, Seattle, WA (US); Rupesh Thakkar, Bellevue, WA (US)

(21) Appl. No.: 16/261,355

(22) Filed: Jan. 29, 2019

(51) Int. Cl. G06Q 10/10; G06F 16/9536

(52) U.S. Cl. CPC G06Q 10/1095; G06F 16/9536

(57) ABSTRACT

Servers and computing devices for efficiently managing database records in a database are disclosed herein. In one embodiment, a database server can be configured to receive and store multiple database records each having data representing a service provider and a time period available for the service. The database server can also provide to the client device, search results having one or more of the database records to be surfaced on the client device to the user. Upon receiving, from the user, a selection of one of the surfaced one or more database records on the client device, automatically creating a calendar item in both (i) a calendar folder of the service provider and (ii) another calendar folder of the user, the calendar item representing an appointment for the service by the user with the service provider at the available time period published by the service provider.

### BACKGROUND

Electronic calendars are software applications designed to provide users with an electronic version of a physical calendar. Such software applications typically provide an appointment book, an address book, and a contact list. For example, an electronic appointment book can provide functionalities such as receiving a description, a date/time, a location, and other information of a meeting, creating a meeting appointment based on the received information, and track a current date/time in order to provide reminders for the scheduled meeting.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Certain electronic calendars lack functionalities for facilitating information searching, appointment making, and management of appointments, tasks, or other types of time centric activities within the electronic calendar applications. For example, in order to create an appointment for a haircut, a user can first use, for instance, a web browser on a client device to search for and study reviews of a hair stylist or salon nearby. Once a hair stylist is selected, the user can then call or email the hair stylist for availability information, match the availability of the hair stylist with the user's schedule, and then set an appointment for a haircut. Once the appointment is set, the user can create a calendar item such as an appointment or task by manually filing out details of the appointment (e.g., identity of the hair stylist, a date/time, a location, etc.) via a user interface of an electronic calendar application. The electronic calendar application can then create the calendar item and track the date/time of the appointment with respect to a current date/time in order to provide reminders to the user.

The foregoing technique for managing time centric activities can be inefficient and cumbersome. For instance, a large amount of network bandwidth and/or computing resources may be expanded to execute various types of applications, such as web browsers, email clients, electronic calendar applications on the client device and obtaining suitable information via a computer network in order to set one appointment. In addition, manually transferring information of a set appointment may be difficult and prone to errors. For example, manually typing the appointment date/time may be challenging when using a soft keyboard on a smartphone. Also, the information entered into the electronic calendar application can be inaccurate. The incorrect appointment information in the electronic calendar application may result in missed appointments, and thus resulting in negative user experience.

Several embodiments of the disclosed technology can address at least some of the foregoing drawbacks by implementing a calendar server that is configured to receive publication of data items representing availability for a service (referred to as “availability records”) by a first user, allow a second user to search the published availability records, and automatically set an appointment between the first and second users based on a selected one of the published availability records. In the haircut example above, the first user (e.g., a hair salon) can publish availability records of various hair stylists (e.g., Jane, Joan, and Jack) working in the hair salon to the calendar server. In certain embodiments, the hair salon and/or the individual hair stylists can also define rules for publishing and/or searching the various availability records. For example, the availability records for Jane can be searched by everyone while those of Joan and Jack can only be seen by a limited group of users, such as repeating customers. In other embodiments, the hair salon can also define a lifetime of the availability records. For instance, one or more of the availability records can expired after an elapsed time, at certain date/time, or based on other suitable criteria.

In response to receiving the published availability records, the calendar server can index and store the availability records as individual database records with associated metadata, such as keywords, associated lifetime, rules, etc. The calendar server can also make the stored availability records searchable by other users within an electronic calendar application. For example, the second user can type a keyword (e.g., “haircut near me”), a location, a desired date/time, etc., in a search field in an electronic calendar application executing on another client device as a search query. Upon receiving a command to submit, the electronic calendar application can transmit data representing the search query from the client device to the calendar server via a computer network. In some embodiments, the electronic calendar application can also transmit to the calendar server identity of the second user, a current location of the second user, or other suitable type of information associated with the second user.

Upon receiving the search query from the second user, the calendar server can search the database to locate a set of availability records based on, for example, the keyword, the current location, the desired date/time, and/or other suitable information. The calendar server can then provide the set of availability records to the electronic calendar application of the second user as search results. In certain implementation, the calendar server can be configured to locate the set of availability records by comparing the available date/time to a schedule of the second user in the calendar server. As such, availability records having available times that conflict with existing calendar items of the second user can be excluded from the search results. In other implementations, the calendar server can be configured to provide the set of availability records and perform conflict checking upon receiving a selection of one of the availability records from the second user. In further implementations, the calendar server can also filter, sort, rank, or perform other suitable operations on the set of availability records provided to the second user.

The calendar server can also be configured to allow the second user to set an appointment within the electronic calendar application. For example, upon surfacing the set of availability records on the client device, the second user can select one of the availability records and transmit a booking request for setting an appointment based on the selected availability record. In one embodiment, the calendar server can be configured to check whether the selected availability record is still valid, for instance, whether the availability record has been removed or the available date/time has been marked as unavailable. In response to determining that the availability record is still valid, the calendar server can be configured to automatically create and store an appointment, task, event, or other suitable types of calendar item on each of the calendars of the first user and the second user. In other embodiments, the calendar server can be configured to transmit an electronic message as a confirmation request to the first user for confirming the appointment before setting the appointment. Upon receiving a positive confirmation response, the calendar server can then create the calendar items for both the first and second users. In further embodiments, the calendar server can also be configured to facilitate prepayment, special requests, route determination, and/or other suitable from within the electronic calendar application.

Several embodiments of the disclosed technology can thus reduce network bandwidth consumption and/or computing loads on the client devices of the first and second users when managing time centric activities. Unlike in some electronic calendar servers, the second user can search, receive availability records, book an appointment, and optionally pay for the booked appointment without leaving the electronic calendar application. As such, execution of multiple applications on the client device of the second user can be reduced and network traffic can be streamlined. Several embodiments of the disclosed technology can also improve user experience of the electronic calendar service provided by the calendar server by facilitating automatic setting of appointments without calling, emailing, or communicating with the other party via other communication channels.

### BRIEF DESCRIPTION OF THE DRAWINGS

FIGS. 1A-1D are schematic diagrams illustrating a computing system implementing management of electronic calendar items during certain stages of operation in accordance with embodiments of the disclosed technology.

FIG. 2 is a schematic diagram illustrating hardware/software components of an event component in accordance with embodiments of the disclosed technology.

FIGS. 3A-3C are flowcharts illustrating processes of intelligent management of calendar items in accordance with embodiments of the disclosed technology.

FIG. 4 is a computing device suitable for certain components of the computing system in FIGS. 1A-1D.

### DETAILED DESCRIPTION

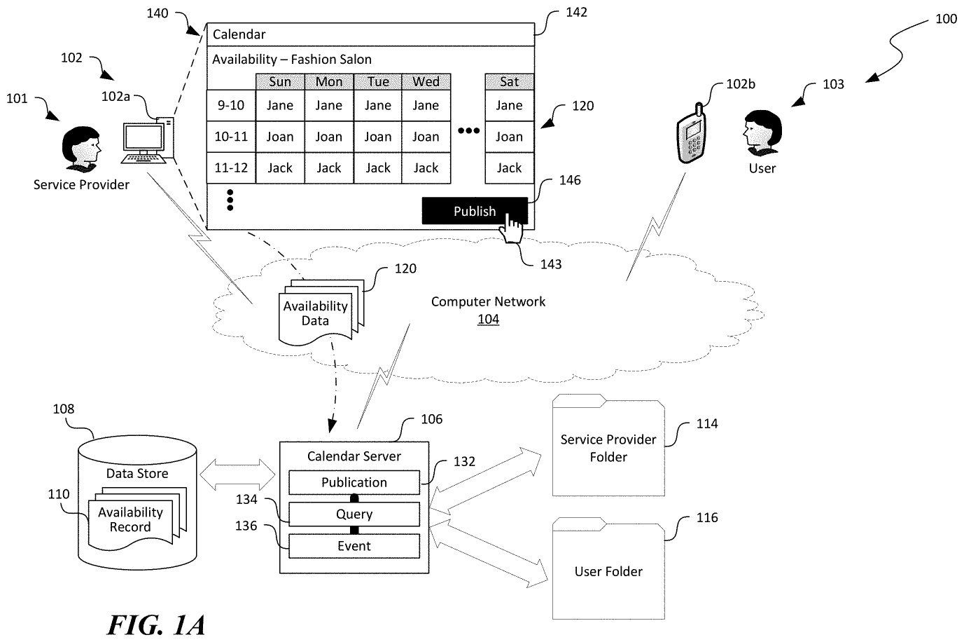

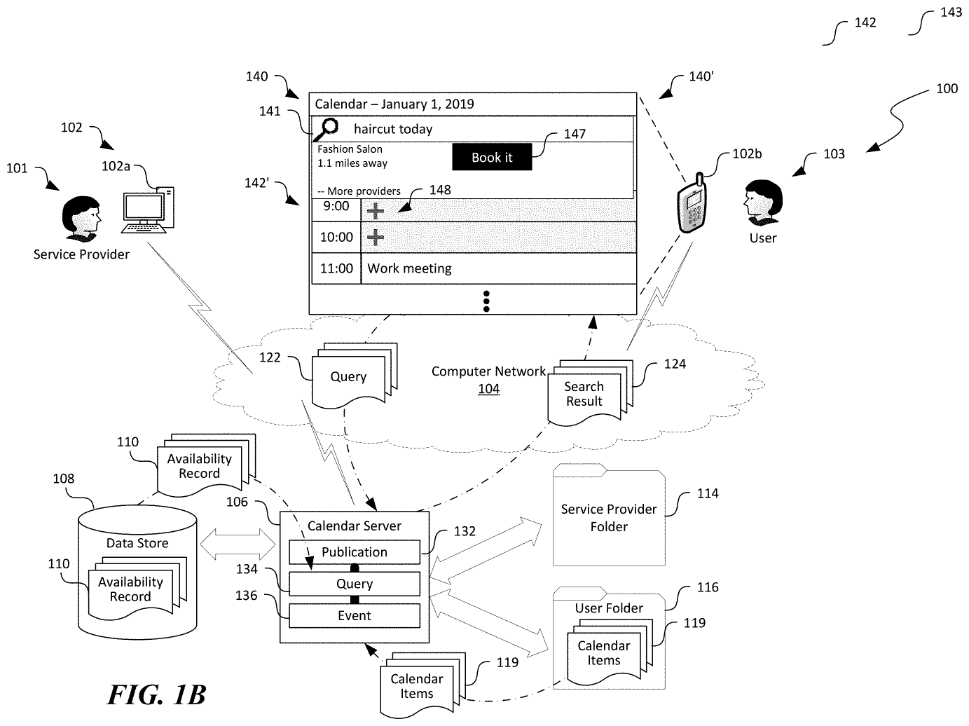

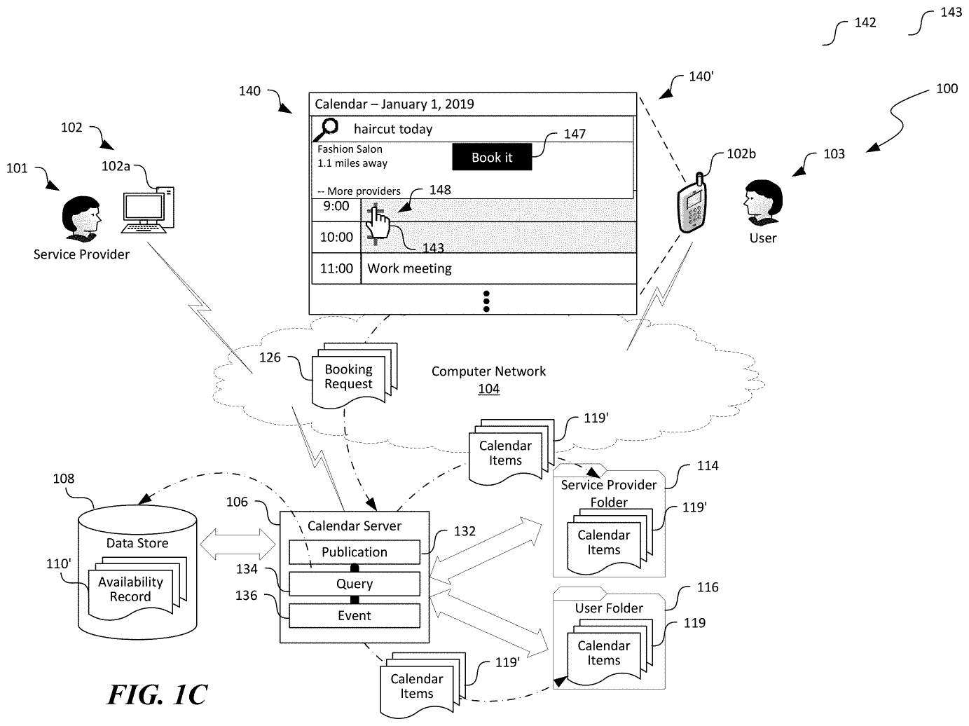

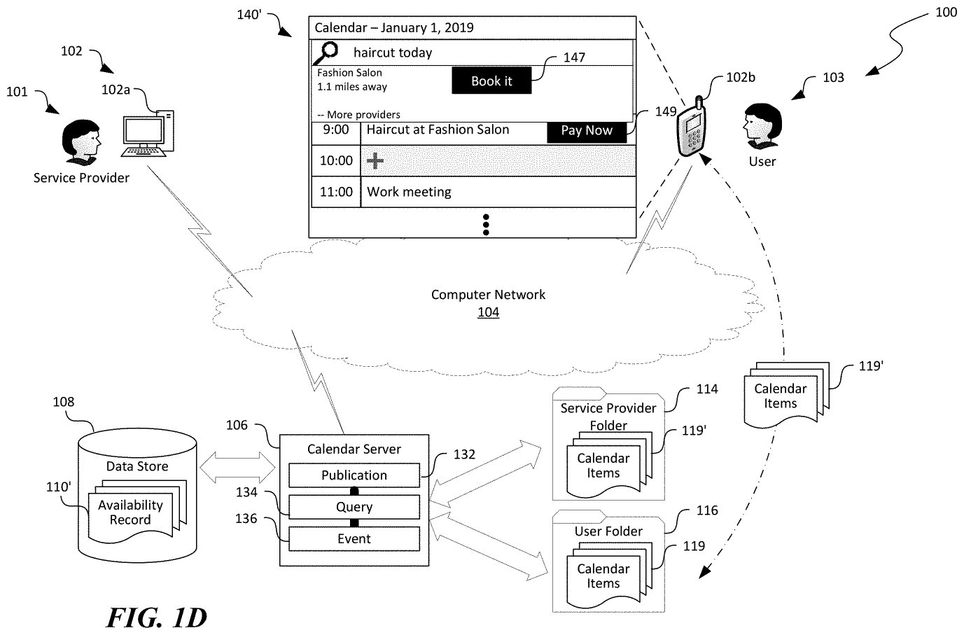

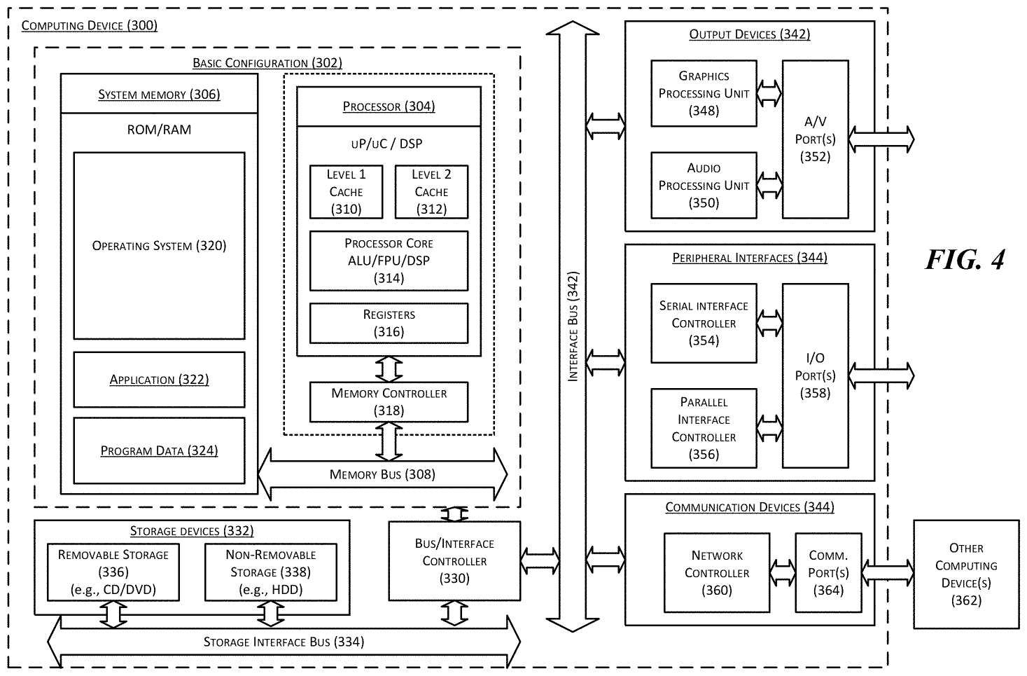

Certain embodiments of systems, devices, components, modules, routines, data structures, and processes for management of electronic calendar items in computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-4.

As used herein, the term “calendar server” generally refers to computer or server dedicated to running such software applications that are configured to provide an electronic version of a physical calendar to one or more users. Such applications typically can provide an appointment book, an address book, and a contact list. For example, an appointment book can provide functionalities such as receiving a description, a date/time, a location, and other information of a meeting, creating a meeting appointment based on the received information, and track a current date/time in order to provide reminders for the scheduled meeting. Examples of such applications include Microsoft Exchange®, qmail, Exim, and sendmail.

A calendar server can also be configured to provide a calendar folder for storing calendar items of a user. The calendar folder can be synchronized with a corresponding folder on one or more client devices accessible by the user via a computer network such as the Internet. Such synchronization can be periodic, on-demand, and/or in other suitable basis. Calendar items can individually include a digital data package containing information of a meeting appointment, a task, an event, reminder, etc. For example, a calendar item representing an appointment can include data identifying an identity of a service provider (or other suitable entities), a location, and a date/time. The calendar item can also include additional metadata such as how far in advance to provide a reminder of the appointment and/or other suitable information.

Also used herein, an “availability record” generally refers to a digital data package containing data representing a date/time that a service provider is available for providing one or more services. An availability record can contain structured or non-structured data representing various data fields. For instance, example data fields can include identification of a service provider, one or more provided service, a location of the service provider, an available date/time, etc. In accordance with embodiments of the disclosed technology, the availability record can also include data fields containing values, parameters, and/or other suitable metadata concerning the availability record, such as restrictions on searchability, a time-to-live, etc. The metadata can be configured by the service provider or automatically generated by a calendar server based on a knowledge database, machine learning, or other suitable sources.

Certain electronic calendars lack functionalities for facilitating efficient setting and managing appointments, tasks, or other types of time centric activities within the electronic calendar applications. For example, a user seeking an appointment for a service may need to use multiple communication channels, such as phones, emails, on-line chats, etc. to set an appointment with a service provider. Once the appointment is set, the user can then create a calendar item such as an appointment or task by manually filing out details of the appointment (e.g., identity of the hair stylist, a date/time, a location, etc.) via a user interface of an electronic calendar application. The electronic calendar application can then create the calendar item and track the date/time of the appointment with respect to a current date/time in order to provide reminders to the user.

The foregoing technique for setting the appointment can be inefficient and cumbersome. A large amount of network bandwidth and/or computing resources may be expanded to execute various types of applications or facilitating communications via various channels. In addition, manually transferring information of a set appointment may be difficult and prone to errors. Several embodiments of the disclosed technology can address at least some of the foregoing drawbacks by implementing a calendar server that is configured to receive publication of data items representing availability for a service (referred to as “availability records”) by a first user, allow a second user to search the published availability records, and automatically set an appointment between the first and second users based on a selected one of the published availability records. As such, the second user can search, receive availability records, book an appointment, and optionally pay for the booked appointment without leaving the electronic calendar application. Thus, execution of multiple applications on the client device of the second user can be reduced and user experience of electronic calendar service can be improved, as described in more detail below with reference to FIGS. 1A-4.

FIGS. 1A-1D are schematic diagrams illustrating a computing system 100 implementing management of electronic calendar items during certain stages of operation in accordance with embodiments of the disclosed technology. In FIG. 1A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 1A, the computing system 100 can include a computer network 104 interconnecting client devices 102 with one or more calendar servers 106 (referred to as “calendar server 106” here in for simplicity). The client devices 102 can individually correspond to a service provider 101 and a user 103. Even though particular components of the computing system 100 are shown in FIG. 1A, in other embodiments, the computing system 100 can also include additional and/or different components or arrangements. For example, in certain embodiments, the computing system 100 can also include additional network storage devices, additional servers, and/or other suitable components (not shown). In other embodiments, the data store 108 may be integrated into the calendar server 106.

The computer network 104 can include an intranet, a wide area network, an internet (e.g., the Internet), or other suitable types of network. The calendar server 106 is also interconnected with multiple calendar folders, such as a service provider folder 114 and a user folder 116 corresponding to the service provider 101 and the user 103, respectively. The calendars folders can be configured to store calendar items such as appointments, tasks, events, reminders, etc. The calendar server 106 can also be interconnected to a data store 108 containing one or more availability records 110. The availability records 110 can include multiple database records containing information of available service, date/time, etc. as described in more detail below. In further embodiments, the availability records 110 may not be present in the data store 108. Instead, the availability records 110 may be provided from external sources, such as additional servers or network storage spaces (not shown).

The client devices 102 can each include a computing device that facilitates corresponding service provider 101 or user 103 to access calendar or other suitable types of computing services provided by the calendar server 106 via the computer network 104. For example, in the illustrated embodiment, the first client device 102a includes a desktop computer corresponding to the service provider 101 while the second client device 102b includes a smartphone corresponding to the user 103. In other embodiments, the client devices 102 can also include laptop computers, tablets, or other suitable computing devices. Even though one service provider 101 and one user 103 are shown in FIG. 1A for illustration purposes, in other embodiments, the computing system 100 can facilitate any suitable number of service providers and users 103 to access suitable types of computing services provided by the calendar server 106.

The client devices 102 can individually include one or more processor that can execute suitable instructions to provide an electronic calendar application 140 configured according to certain aspects of the disclosed technology. For instance, as shown in FIG. 1A, the electronic calendar application 140 can be configured to allow the service provider 101 to input availability data 120 for one or more services provided by the service provider 101 and publish such availability data 120 to the calendar server 106. In the illustrated example, the service provider 101 can be an administrator or owner of a hair salon (i.e., “Fashion Salon”). In other examples, the service provider 101 can be an individual stylist or other suitable entities.

The electronic calendar application 140 can include a user interface 142 configured to allow the service provider 101 to input availability data 120. For instance, the input availability data 120 includes “Jane” is available from “9-10,” “Joan” is available from “10-11,” and “Jack” is available from “11-12” over days of a week shown in a table format on the user interface 142. Even though particular example interface elements are shown in FIG. 1A for receiving the availability data 120, in other embodiments, the user interface 142 of the electronic calendar application 140 can include dropdown menus, selection buttons, or other suitable types of interface elements configured to allow the service provider 101 to input the availability data 120.

In certain embodiments, the service provider 101 and/or the individual hair stylists can also define rules for publishing and/or searching the availability data 120. For example, the availability information for “Jane” can be searched by everyone while those of “Joan” and “Jack” can only be seen by a limited group of users, such as repeating customers. In other embodiments, the service provider 101 can also define a lifetime of the availability data 120. For instance, one or more of the availability information can expired after an elapsed time, at certain date/time, or based on other suitable criteria.

The user interface 142 can also include a “Publish” button 146 upon actuation by the service provider 101 (as represented by the cursor 143) causes the electronic calendar application 140 to transmit the received availability data 120 from the first client device 102a to the calendar server 106. In some embodiments, publication of the availability data 120 can be performed automatically according to a user configuration or suitable settings. As shown in FIG. 1A, the calendar server 106 can also include one or more processors (not shown) executing suitable instructions to provide a publication component 132, a query component 134, and an event component 136 operatively coupled to one another. Though particular components of the calendar server 106 is shown in FIG. 1A and other figures herein, in other embodiments, the calendar server 106 can also include input/output, security, and/or other suitable types of components.

The publication component 132 can be configured to receive the availability data 120 of the service provider 101 from the first client device 102a. The publication component 132 can also be configured to organize and store the received availability data 120 as individual availability records 110 in the data store 108. In certain embodiments, each available date/time can correspond to an availability record 110. As such, one example availability record 110 can include data representing “Jane” from “Fashion Salon” is available from “9-10” every day of the week. In other embodiments, the availability records 110 can be organized to correspond to each stylist, to the service provider 101, or in other suitable fashions.

The query component 134 can be configured to facilitate searching the stored availability record 110 in the data store 108 by the user 103. For instance, as shown in FIG. 1B, the second client device 102b can include one or more processor (not shown) executing suitable instructions to provide an electronic calendar application 140′. In the illustrated embodiment, the electronic calendar application 140′ can include a mobile version of the electronic calendar application 140 (FIG. 1A). The electronic calendar application 140′ can include a user interface 142′ configured to display one or more calendar items of the user 103. For instance, the user interface 142′ displays a day schedule of the user 103 for Jan. 1, 2019, that includes a “Work meeting” from 11:00 AM to 12:00 PM. In other embodiments, the electronic calendar application 140′ can include a different application, a web-based application, or other suitable types of electronic calendar application.

As shown in FIG. 1B, the electronic calendar application 140′ can be configured to provide a searching function via, for instance, a search bar 141. In one implementation, typing into the search bar 141 can cause the electronic calendar application 140′ to transmit a query 122 to the calendar server 106. In other implementations, the user 103 can enter the searching terms (e.g., “haircut today”) into the search bar 141 and initiate the search by clicking on the magnifier symbol, or via other suitable means. In response, the electronic calendar application 140′ can transmit the query 122 to the calendar server 106. The query 122 can include the search terms entered into the search bar 141 and optionally data representing one or more of a location of the user 103, an identity of the user 103 (with prior user approval), or other suitable information.

Upon receiving the query 122 from the second client device 102b, the query component 134 can be configured to perform a search of the availability records 110 in the data store 108 based on, for example, the keyword, the current location, the desired date/time, and/or other suitable information. The query component 134 can then provide a set of availability records 110 as search result 124 to the electronic calendar application 140′ at the second client device 102b. In certain implementation, the query component 134 can be configured to locate the set of availability records 110 by comparing the available date/time to a schedule of the user 103 in the calendar server 106. For instance, the query component 134 can be configured to retrieve one or more calendar items 119 from the user folder 116 corresponding to the user 103. As such, availability records 110 having available times that conflict with the existing calendar item of the user 103 can be excluded from the search result 124. In the illustrated example, the retrieved calendar item 119 can include data representing the “Work meeting” from 11:00 AM to 12:00 PM for the user 103. As such, the query component 134 can be configured to exclude any availability records 110 that has an available time from 11:00 AM to 12:00 PM on Jan. 1, 2019. In further implementations, the calendar server can also filter, sort, rank, or perform other suitable operations on the set of availability records 110 provided to the user 103.

Upon receiving the search result 124, the electronic calendar application 140′ can present the individual availability records 110 in the search result 124 on the user interface 142′. For instance, as shown in FIG. 1B, the electronic calendar application 140′ can present one or more of the service provider 101 (e.g., “Fashion Salon”) on the user interface 142′. The electronic calendar application 140′ can also be configured to show which time period(s) on the calendar of the user 103 is available for setting an appointment. In the illustrated example, the available time periods are from 9:00 AM to 10:00 AM and from 10:00 AM to 11:00 AM, indicated with plus signs 148 (or other suitable interface elements).

The user 103 can then set an appointment with the presented service provider 101 by simply actuating the plus signs 148. For instance, as shown in FIG. 1C, the user 103 can actuate the plus sign 148 for the 9:00 AM to 10:00 AM time period, as represented by the cursor 143. In response to receiving the actuation, the electronic calendar application 140′ can be configured to transmit a booking request 126 from the second client device 102b to the calendar server 106. The booking request 126 can include data representing the selected time period, as well as identity of the user 103 (with user approval) and/or other suitable information.

Upon receiving the booking request 126, in one embodiment, the event component 136 can be configured to check whether the selected availability record 110 is still valid, for instance, whether the availability record 110 corresponding to the 9:00 AM to 10:00 AM time period has been removed or the available date/time has been marked as unavailable. In response to determining that the availability record 110 is still valid, the event component 136 can be configured to automatically create and store an appointment, task, event, or other suitable types of calendar item 119′ in each of the service provider folder 114 and the user folder 116 corresponding to the service provider 101 and the user 103, respectively. In other embodiments, the event component 136 can be configured to transmit an electronic message (not shown) as a confirmation request to the service provider 101 for confirming the appointment before setting the appointment. Upon receiving a positive confirmation response, the event component 136 can then create the calendar items 119′ for both the service provider 101 and the user 103.

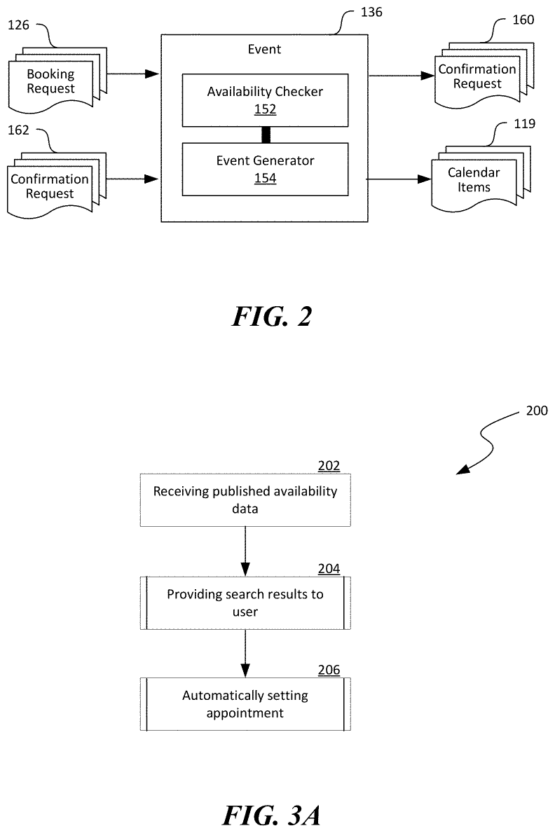

As shown in FIG. 1D, the automatically created calendar item 119′ can then be pushed, synchronized, and/or otherwise transmitted to the first client device 102a (FIG. 1A) and the second client device 102b. In the illustrated example, the 9:00 AM to 10:00 AM time period of the user 103 now shows an appointment as “Haircut at Fashion Salon.” In further examples, the event component 136 can also be configured to facilitate prepayment (e.g., via the “Pay Now” button 149″), special requests, driving route determination, and/or other suitable from within the electronic calendar application 140′. Example modules of the event component 136 are described in more detail below with reference to FIG. 2.

Several embodiments of the disclosed technology can thus reduce network bandwidth consumption of the computer network 104 and/or computing loads on the client devices 102 when managing time centric activities. Unlike some other electronic calendar services, the user 103 can search, receive availability records 110, book an appointment, and optionally pay for the booked appointment without leaving the electronic calendar application 140′. As such, execution of multiple applications on the client device 102 can be reduced and network traffic can be streamlined. Several embodiments of the disclosed technology can also improve user experience of the electronic calendar service provided by the calendar server 106 by facilitating automatic setting of appointments without calling, emailing, or communicating with the other party via other communication channels.

FIG. 2 is a schematic diagram illustrating hardware/software components of an event component 136 in accordance with embodiments of the disclosed technology. As shown in FIG. 2, the event component 136 can include an availability checker 152 and an event generator 154 operatively coupled to one another. The availability checker 152 can be configured to check whether a date/time period of a selected availability record 110 (FIG. 1A) in the booking request 126 is still valid, for example, by confirming that the selected availability record 110 is still in the data store 108 (FIG. 1A), has not expired, has not been marked as unavailable, or via other suitable techniques. In some embodiments, the availability checker 152 can also be configured to transmit a confirmation request 160 to, for example, the service provider 101 (FIG. 1A). In response to receiving a positive confirmation response 162 from the service provider 101, the availability checker 152 can indicate to the event generator 154 that the date/time period in the selected availability record 110 is still valid. In response to receiving the indication from the availability checker 152, the event generator 154 can then automatically set the appointment by creating the calendar items 119 in both the service provider's folder 114 (FIG. 1D) and the user's folder 116 (FIG. 1D).

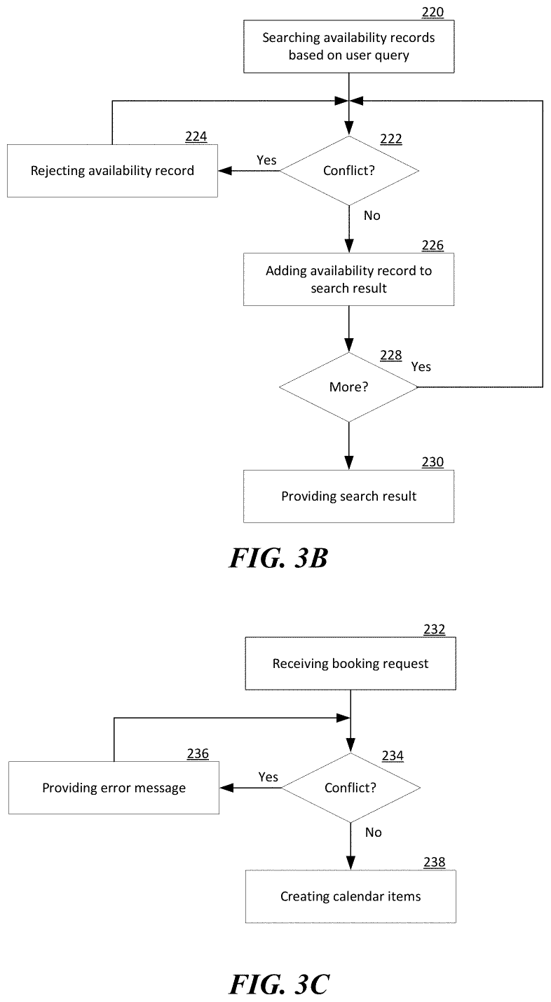

FIGS. 3A-3C are flowcharts illustrating processes of intelligent management of calendar items in accordance with embodiments of the disclosed technology. Even though embodiments of the processes are described below in the context of the computing system 100 in FIGS. 1A-1D, in other embodiments, the processes can also be implemented in computing systems with additional and/or different components.

As shown in FIG. 3A, a process 200 can include receiving published availability data at stage 202. The published availability data can include an identity of a service provider, one or more services provided by the service provider, and one or more available date/time periods, as described above with reference to FIG. 1A. The process 200 can then include providing search results to a user upon receiving a search query for service at stage 204. In certain embodiments, the search query can be received from an electronic calendar application executing on a client device, as described above with reference to FIG. 1B. In other embodiment, the search query can be received from other suitable sources. Based on the received search query, availability records can be searched to generate search result. Example operations of providing search results are described below with reference to FIG. 3B. The process 200 can then include automatically setting an appointment upon receiving a selection from the user of one of the availability records in the search result at stage 206. Example operations of automatically setting the appointment are described below with reference to FIG. 3C.

As shown in FIG. 3B, operations of providing search result can include searching availability records based on a received user query to locate a set of availability records at stage 220. The operations can then include a decision stage 222 to determine whether any of the located availability records include a date/time that conflicts with existing calendar items of the user. In response to determining that a conflict exits, the availability record is rejected at stage 224. Otherwise, the availability record is added to the search result at stage 226. The operations can then include another decision stage 228 to determine whether additional availability records exist in the set of availability records. In response to determine that additional availability records exist, the operation revert to determining whether a conflict exists at stage 222. Otherwise, the operations proceed to providing the search result to the user at stage 230.

As shown in FIG. 3C, operations of automatically setting an appointment can include receiving a booking request at stage 232. The operations can then include a decision stage 234 to determine whether a selected availability record has a date/time period that conflicts with (e.g., at the same or overlapping date/time) an existing calendar item of the user. In response to determining that a conflict exits, the operations include providing an error message at stage 236. Otherwise, the operations include creating the calendar items at stage 238 as described above with reference to FIGS. 1C and 1D.

FIG. 5 is a computing device 300 suitable for certain components of the distributed computing system 100 in FIGS. 1A-1D. For example, the computing device 300 can be suitable for the calendar server 106 and/or the client devices 102 of FIGS. 1A-1D. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for managing electronic calendar items in a computing system having a server interconnected to client devices by a computer network, the method comprising:
receiving, via the computer network, data representing a query from a user for a service via a client device; and
in response to receiving the query from the user, at the server,
searching, based on the received query from the user, multiple database records individually having data representing a service provider and a time period available for the service previously published to the server by the service provider;
transmitting, via the computer network and to the client device, search results having one or more of the database records to be surfaced on the client device to the user; and
upon receiving, from the user and via the client device, a selection of one of the surfaced one or more database records on the client device, automatically creating a calendar item in both (i) a calendar folder of the service provider and (ii) another calendar folder of the user, the calendar item representing an appointment for the service by the user with the service provider at the available time period published by the service provider.

2. The method of claim 1 wherein the data representing the query includes receiving the data representing the query from the user from a calendar application executing on the client device.

3. The method of claim 1 wherein searching the multiple database records includes searching, based on the received query from the user, multiple database records according to one or more rules associated with the database records and published by the corresponding service providers, the one or more rules limiting visibility of one or more database records to the user.

4. The method of claim 1 wherein searching the multiple database records includes searching, based on the received query from the user, multiple database records according to one or more of a location of the user, a location of the service providers, or a requested time period for the service by the user.

5. The method of claim 1 wherein:
searching the multiple database records includes searching, based on the received query from the user, multiple database records according to one or more existing calendar items in the calendar folder of the user; and
transmitting the search results includes transmitting the search results having one or more database records individually having an available time period that does not conflict with the one or more existing calendar items in the calendar folder of the user.

6. The method of claim 1, further comprising:
upon receiving, from the user and via the client device, a selection of one of the surfaced one or more database records on the client device,
transmitting, via the computer network, a confirmation request to the service provider; and
upon receiving a confirmation response from the service provider, automatically creating the calendar item in both (i) the calendar folder of the service provider and (ii) the another calendar folder of the user.

7. The method of claim 1, further comprising:
upon receiving, from the user and via the client device, a selection of one of the surfaced one or more database records on the client device,
verifying that the time period available for the service in the selected database record is still valid; and
upon verification, automatically creating the calendar item in both (i) the calendar folder of the service provider and (ii) the another calendar folder of the user.

8. The method of claim 1, further comprising:
upon receiving, from the user and via the client device, a selection of one of the surfaced one or more database records on the client device,
determining whether the time period in the selected database record conflicts with any existing calendar items in the calendar folder of the user; and
in response to determining that the time period in the selected database record does not conflict with any existing calendar items in the calendar folder of the user, automatically creating the calendar item in both (i) the calendar folder of the service provider and (ii) the another calendar folder of the user.

9. The method of claim 1, further comprising subsequent to automatically creating the calendar item in both (i) the calendar folder of the service provider and (ii) the another calendar folder of the user, modifying the selected database record to indicate that the corresponding time period is no longer available.

10. A computing device for managing electronic calendar items, comprising:
a processor; and
a memory operatively coupled to the processor, the memory having instructions executable by the processor to cause the computing device to:
upon receiving, via a computer network, data representing a query from a user for a service via a client device,
search a set of database records each having data representing a service provider and a time period available for the service previously published to the computing device by the service provider to generate a subset of the database records based on the received query;
transmit, via the computer network and to the client device, the subset of the database records to be surfaced on the client device to the user; and
upon receiving, from the user and via the client device, data indicating one of the surfaced subset of database records is selected on the client device, automatically create a calendar item in a first calendar folder of the service provider and a second calendar folder of the user, the calendar item representing an appointment for the service by the user with the service provider at the available time period published by the service provider.

11. The computing device of claim 10 wherein to search the set of database records includes to search, based on the received query from the user, the set of database records according to one or more rules associated with the database records and published by the corresponding service providers, the one or more rules limiting visibility of one or more database records to the user.

12. The computing device of claim 10 wherein to search the set of database records includes to search, based on the received query from the user, the set of database records according to one or more of a location of the user, a location of the service providers, or a requested time period for the service by the user.

13. The computing device of claim 10 wherein:
to search the multiple database records includes to search, based on the received query from the user, the set of database records according to one or more existing calendar items in the second calendar folder of the user; and
to transmit the subset of the database records includes to transmit the subset of database records individually having an available time period that does not conflict with the one or more existing calendar items in the second calendar folder of the user.

14. The computing device of claim 10 wherein the memory includes additional instructions executable by the processor to cause the computing device to:
upon receiving, from the user and via the client device, data indicating one of the surfaced subset of database records is selected on the client device,
transmit, via the computer network, a confirmation request to the service provider; and
upon receiving a confirmation response from the service provider, automatically create the calendar item in the first calendar folder of the service provider and the second calendar folder of the user.

15. The computing device of claim 10 wherein the memory includes additional instructions executable by the processor to cause the computing device to:
upon receiving, from the user and via the client device, data indicating one of the surfaced subset of database records is selected on the client device,
verify that the time period available for the service in the selected database record is still valid; and
upon verification, automatically create the calendar item in the first calendar folder of the service provider and the second calendar folder of the user.

16. The computing device of claim 10, further comprising:
upon receiving, from the user and via the client device, data indicating one of the surfaced subset of database records is selected on the client device,
determine whether the time period in the selected database record conflicts with any existing calendar items in the second calendar folder of the user; and
in response to determining that the time period in the selected database record does not conflict with any existing calendar items in the second calendar folder of the user, automatically create the calendar item in the first calendar folder of the service provider and the second calendar folder of the user.

17. A method for managing electronic calendar items in a computing system having a server interconnected to client devices by a computer network, the method comprising:
selecting, using a calendar application executed at a client device, a time period as being available for a service by a service provider;
publishing the selected time period as being available for the service to a server by transmitting, via a computer network, data representing the service provider and the time period available for the service by the service provider; and
subsequent to publishing the selected time period to the server, receiving at the calendar application on the client device, data representing a new appointment for the service with a user at the selected time period published to the server.

18. The method of claim 17, further comprising:
setting, at the client device, a rule associated with the published time period to the server, the rule limiting visibility of the service provider to a set of users based on corresponding priority levels.

19. The method of claim 17, further comprising:
subsequent to publishing the selected time period to the server, receiving at the client device,
a confirmation request from the server for confirming that the selected time period is still available; and
in response to receiving the confirmation request, transmitting a confirmation response to confirm that the selected time period is still available.

20. The method of claim 17, further comprising:
subsequent to publishing the selected time period to the server, receiving, from the server, a notification that the published time period is no longer available.
